(19) United States
(12) Patent Application Publication
(10) Pub. No.: US 2020/0233269 A1
(43) Pub. Date: Jul. 23, 2020

(54) SURFACE LIGHT SOURCE DEVICE AND LIQUID CRYSTAL DISPLAY APPARATUS

(71) Applicant: Mitsubishi Electric Corporation, Tokyo (JP)

(72) Inventors: Saki MAEDA, Tokyo (JP); Eiji NIIKURA, Tokyo (JP); Tomohiko SAWANAKA, Tokyo (JP); Masaaki TAKESHIMA, Tokyo (JP); Shinya SUGINO, Tokyo (JP); Takeshi YAMAMOTO, Tokyo (JP)

(73) Assignee: Mitsubishi Electric Corporation, Tokyo (JP)

(21) Appl. No.: 16/088,208

(22) PCT Filed: Apr. 24, 2017
(86) PCT No.: PCT/JP2017/016142

§ 371 Date: Sep. 25, 2018

(30) Foreign Application Priority Data
Apr. 25, 2016 (JP) 2016-086683

(51) Int. Cl. G02F 1/13357

(52) U.S. Cl. CPC G02F 1/133611; G02F 1/133603; G02F 2001/133607; G02F 1/133606

(57) ABSTRACT

A surface light source device includes: a source to emit light including first rays and second rays emitted in mutually perpendicular directions; and an element to change a light distribution of the light. The element includes: an incident surface to receive the first and second rays; a layer including a material for diffusing the first and second rays; a first surface through which an optical axis of the element passes, part of the first rays reaching the first surface after passing through the layer without being diffused by the material; a second surface extending from the first surface toward the source, part of the second rays reaching the second surface after passing through the layer without being diffused by the material; and a reflecting surface facing the first surface, part of the first rays being reflected by the reflecting surface toward the second surface after reflected by the first surface.

### TECHNICAL FIELD

The present invention relates to a surface light source device and a liquid crystal display apparatus.

### BACKGROUND ART

A liquid crystal panel included in a liquid crystal display apparatus does not emit light by itself. Thus, the liquid crystal display apparatus includes a backlight device (surface light source device) behind the liquid crystal panel as a light source for illuminating the liquid crystal panel.

As a backlight device, there is known a direct backlight device in which multiple light emitting diodes (referred to below as LEDs) are arranged.

Small, high-power LEDs with high efficiency have recently been developed. Thus, even if the number of LEDs used in a backlight device is reduced, it is possible to obtain the same brightness as before, according to calculations.

A surface light source device according to the present invention emits planar light with high uniformity in brightness distribution. Thus, it can also be used for purposes other than backlight of liquid crystal display apparatuses. For example, the surface light source device can be used as an illumination device used for room illumination or the like.

The surface light source device according to the present invention can also be used for, for example, an advertisement display device that illuminates a photograph or the like from behind.

For example, when a backlight of a liquid crystal display apparatus is taken as an example, Patent Literature 1 discloses a planar irradiation light source in which a cylindrical lens is disposed to cover one or more point-like light sources disposed on a supporting substrate.

### CITATION LIST

### Patent Literature

Patent Literature 1: Japanese Patent Application Publication No. 2006-286608 (paragraphs 0007-0009 and FIG. 1)

### SUMMARY OF INVENTION

### Technical Problem

However, in Patent Literature 1, when light passes from the medium of the cylindrical lens into air, reflected light occurs at the interface. The amount of the reflected light increases as the divergence angle of light from the light sources increases. This reduces the amount of radiated light.

The present invention is intended to provide a surface light source device having improved light use efficiency by use of light rays reflected by a light emitting surface of a light distribution control element.

### Solution to Problem

A surface light source device includes a light source to emit light, and a light distribution control element to receive the light and change a light distribution of the received light. The light includes a first light ray and a second light ray. The light source includes a first light emission surface to emit the first light ray; and a second light emission surface to emit the second light ray in a direction perpendicular to a direction in which the first light ray is emitted, the second light emission surface being formed in a vicinity of the first light emission surface. The light distribution control element includes: a first light emitting surface formed at a position through which an optical axis of the light distribution control element passes, the first light emitting surface being a surface at which the first light ray arrives; a second light emitting surface disposed at an end of the first light emitting surface and formed to extend toward the light source in a direction of the optical axis, the second light emitting surface being a surface at which the second light ray arrives; and a light reflecting surface disposed at a position facing the first light emitting surface, the light reflecting surface reflecting, toward the second light emitting surface, the first light ray reflected by the first light emitting surface. The second light emitting surface is inclined so that a distance between the second light emitting surface and the optical axis decreases from the light source toward the first light emitting surface. The light reflecting surface has a convex shape projecting toward the first light emitting surface.

### Advantageous Effects of Invention

According to the present invention, it is possible to improve light use efficiency.

### BRIEF DESCRIPTION OF DRAWINGS

FIG. 1 is a configuration diagram schematically illustrating a configuration of a liquid crystal display apparatus 100 (including a surface light source device 200) according to a first embodiment of the present invention.

FIG. 2 is a diagram illustrating behavior of light rays emitted from a light source 7 of the surface light source device 200 according to the first embodiment of the present invention when the light rays pass through a light distribution control element 6.

FIG. 3 is a diagram illustrating behavior of light rays emitted from the light source 7 of the surface light source device 200 according to the first embodiment of the present invention when the light rays are reflected inside the light distribution control element 6 and pass therethrough.

FIG. 4 is a diagram illustrating behavior of light rays emitted from the light source 7 of the surface light source device 200 according to the first embodiment of the present invention when the light rays pass through the light distribution control element 6.

FIG. 5 is a diagram illustrating a configuration of a light distribution control element 6a of a first modification example of a surface light source device 200 according to the first modification example of the present invention.

FIG. 6 is a diagram illustrating a configuration of a light distribution control element 6b of a second modification example of a surface light source device 200 according to the second modification example of the present invention.

FIG. 7 is a configuration diagram schematically illustrating a configuration of a liquid crystal display apparatus 110 (including a surface light source device 210) according to a fourth modification example of the present invention.

FIG. 8 is a diagram illustrating behavior of light rays emitted from a light source 7 of the surface light source device 210 according to the fourth modification example of the present invention when the light rays pass through a light distribution control element 8.

FIG. 9 is a diagram illustrating behavior of light rays emitted from the light source 7 of the surface light source device 210 according to the fourth modification example of the present invention when the light rays are reflected inside the light distribution control element 8 and pass therethrough.

FIG. 10 is a diagram illustrating behavior of light rays emitted from the light source 7 of the surface light source device 210 according to the fourth modification example of the present invention when the light rays pass through the light distribution control element 8.

FIG. 11 is a configuration diagram schematically illustrating a configuration of a liquid crystal display apparatus 120 (including a surface light source device 220) according to a fifth modification example of the present invention.

### DESCRIPTION OF EMBODIMENTS

Surface light source devices described in the following embodiments emit planar light using multiple light sources. Liquid crystal display apparatuses display images on liquid crystal panels by illuminating the liquid crystal panels from behind using the surface light source devices.

Since reflected light occurs at a lens surface, it is preferable to use the reflected light as illumination light to improve uniformity of radiated planar light. In particular, it is difficult to suppress reduction in the amount of light on the periphery of an irradiation region.

The present invention is intended to provide a surface light source device having improved uniformity of planar light by use of light rays reflected by a light emitting surface of a light distribution control element.

### First Embodiment

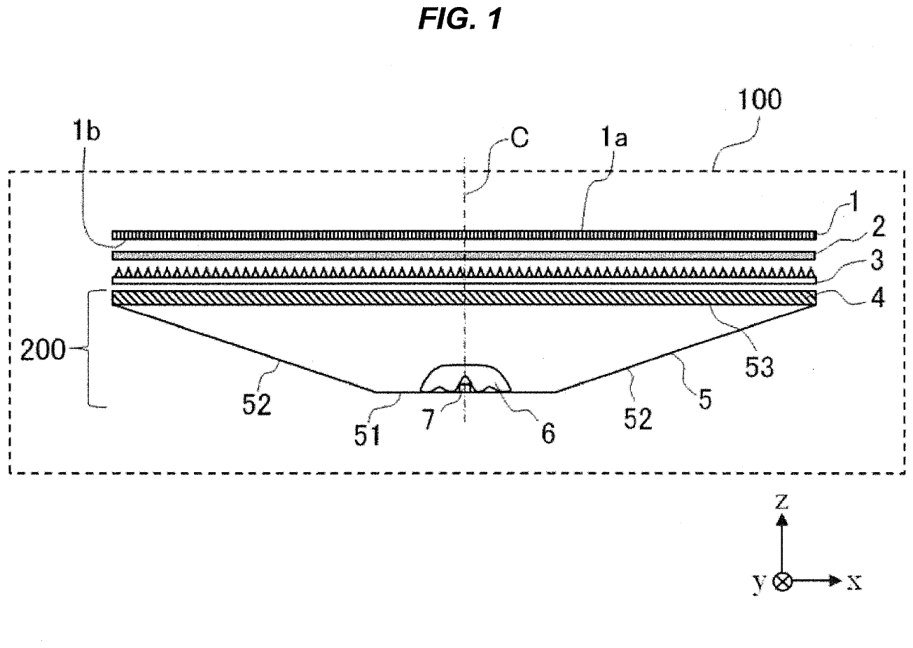

FIG. 1 is a configuration diagram schematically illustrating a configuration of a liquid crystal display apparatus 100 (including a surface light source device 200) according to a first embodiment.

In each of the following embodiments, to facilitate description, the coordinate axes of an xyz orthogonal coordinate system are shown in each drawing.

Typically, a liquid crystal display apparatus is arranged so that a direction of a long edge of a liquid crystal panel is horizontal. In the following embodiments, description will be made on the assumption that the y axis direction is a horizontal direction and the x axis direction is a vertical direction.

As described later, for example, in a case where a light distribution control element is a cylindrical lens, in particular when multiple light distribution control elements are arranged to extend in the horizontal direction, a direction of a long edge of a liquid crystal panel may be vertical. A horizontal direction of a liquid crystal display apparatus is, for example, a left-right direction of a displayed image. A vertical direction of a liquid crystal display apparatus is, for example, an up-down direction of the displayed image.

In the following description, it will be assumed that a direction of a short edge of a liquid crystal panel (liquid crystal display element) 1 is the x axis direction (the left-right direction in FIG. 1); a direction of a long edge of the liquid crystal panel 1 is the y axis direction (the direction perpendicular to the plane of the paper on which FIG. 1 is drawn); a direction perpendicular to an x-y plane that is a plane including the x axis and y axis is the z axis direction (the up-down direction in FIG. 1).

It will be assumed that as one looks from a display surface side of the liquid crystal display apparatus, a left direction is a positive direction (+y axis direction) of the y axis and a right direction is a negative direction (−y axis direction) of the y axis. “As one looks from a display surface side” indicates looking from the +z axis direction side to the −z axis direction side. It will be assumed that an upward direction of the liquid crystal display apparatus is a positive direction (+x axis direction) of the x axis and a downward direction is a negative direction (−x axis direction) of the x axis. It will also be assumed that a direction in which the liquid crystal display apparatus displays an image is a positive direction (+z axis direction) of the z axis and the opposite direction is a negative direction (−Z axis direction) of the z axis.

The +z axis direction side will be referred to as the display surface side. The −z axis direction side will be referred to as the back surface side.

<Configurations of Liquid Crystal Display Apparatus 100 and Surface Light Source Device 200>

As illustrated in FIG. 1, the liquid crystal display apparatus 100 according to the first embodiment includes the liquid crystal panel 1 of a transmission type and the surface light source device 200. The liquid crystal display apparatus 100 may also include an optical sheet 2 or 3.

As illustrated in FIG. 1, the surface light source device 200 includes a light distribution control element 6 and light sources 7. The surface light source device 200 may also include a diffusion plate 4 or a reflector 5.

In FIG. 1, the surface light source device 200 radiates light to a back surface 1b (surface on the −z axis direction side) of the liquid crystal panel 1 through the optical sheets 3 and 2. These components 1, 2, 3, and 200 are arranged in order from the +z axis direction side to the −z axis direction side.

The liquid crystal panel 1 converts light into image light. “Image light” refers to light having image information.

A display surface 1a of the liquid crystal panel 1 is, for example, a surface parallel to the x-y plane. The display surface 1a is a surface on the +z axis direction side of the liquid crystal panel 1. A liquid crystal layer of the liquid crystal panel 1 has a planar structure extending in directions parallel to the x-y plane.

The display surface 1a of the liquid crystal panel 1 typically has a rectangular shape. Thus, each adjacent two of the edges of the display surface 1a are perpendicular to each other. For example, the short edges of the display surface 1a are parallel to the x axis. The long edges of the display surface 1a are parallel to the y axis. However, the display surface may have other shapes.

The optical sheet 2 suppresses optical effects, such as minor illumination unevenness.

The optical sheet 3 has a function of directing light emitted from the diffusion plate 4 in a normal direction to the display surface 1a of the liquid crystal panel 1.

The diffusion plate 4 diffuses light passing therethrough. “Diffuses” refers to spreading and scattering. It indicates that light scatters. The diffusion plate 4 scatters light passing therethrough.

The diffusion plate 4 has, for example, a thin plate shape. The diffusion plate 4 may also be sheet-like, for example. It may also be a film formed on a substrate. The substrate is, for example, a transparent plate for forming a diffusion film. The substrate supports a diffusion film.

The diffusion plate 4 is located on the +z axis side of the reflector 5. The diffusion plate 4 is disposed to cover an opening 53 of the reflector 5. The diffusion plate 4 is disposed at a light emitting surface of the surface light source device 200.

In the following description, there are descriptions, such as “Light rays reach the diffusion plate 4.” As described above, as an example, the diffusion plate 4 is disposed in the opening 53 of the reflector 5. Thus, “Light rays reach the diffusion plate 4” can be rephrased as “Light rays reach the opening 53.” Also, the opening 53 or diffusion plate 4 functions as the light emitting surface of the surface light source device 200. Thus, “Light rays reach the diffusion plate 4” can be rephrased as “Light rays reach the light emitting surface of the surface light source device 200.” The diffusion plate 4 and the opening 53 of the reflector 5 is described as an example of the light emitting surface of the surface light source device 200.

The reflector 5 is a member that reflects light. Thus, for example, when the reflector 5 is a separate or independent member, the reflector 5 is a reflecting member. The reflector 5 may be, for example, a part of a housing of the liquid crystal display apparatus 100.

The reflector 5 includes at least one bottom surface 51 and at least one side surface 52. In the first embodiment, the reflector 5 includes one bottom surface 51 and four side surfaces 52. Thus, the reflector 5 includes five surfaces. The reflector 5 has a box shape.

The bottom surface 51 is, for example, a surface parallel to the x-y plane. The bottom surface 51 has, for example, a rectangular shape.

The side surfaces 52 are connected to the respective edges of the bottom surface 51. The side surfaces 52 are inclined so that a light emitting region becomes wider in the +z axis direction. The light emitting region is, for example, a region on a plane parallel to the x-y plane. Reflecting surfaces of the side surfaces 52 face in the +z axis direction. The reflecting surfaces of the side surfaces 52 are inner surfaces of the reflector 5.

When the bottom surface 51 is rectangular, two of the four side surfaces 52 connected to the edges of the bottom surface 51 parallel to the y direction are inclined so that the distance between the two side surfaces 52 increases in the +z axis direction. The side surface 52 on the −x axis direction side is rotated counterclockwise relative to a y-z plane about the connection with the bottom surface 51 as viewed from the −y axis direction. The side surface 52 on the +x axis direction side is rotated clockwise relative to a y-z plane about the connection with the bottom surface 51 as viewed from the −y axis direction.

Also, two of the four side surfaces 52 connected to the edges of the bottom surface 51 parallel to the x direction are inclined so that the distance between the two side surfaces 52 increases in the +z axis direction. The side surface 52 on the −y axis direction side is rotated toward a front side (the −y axis direction side) relative to a z-x plane about the connection with the bottom surface 51 as viewed from the −y axis direction. The side surface 52 on the +y axis direction side is rotated toward a back side (the +y axis direction side) relative to a z-x plane about the connection with the bottom surface 51 as viewed from the −y axis direction.

The inside of the reflector 5 is a reflecting surface. An inner surface of the bottom surface 51 is a reflecting surface. Inner surfaces of the side surfaces 52 are reflecting surfaces. The reflecting surface of the reflector 5 may be, for example, a diffuse reflection surface.

The reflector 5 may employ, for example, a light reflecting sheet with resin, such as polyethylene terephthalate, as its base material, a light reflecting sheet obtained by evaporating metal onto a surface of a substrate, or the like. The reflecting film is formed on the substrate. Here, the substrate need not be transparent.

The opening 53 is formed on the +z axis direction side of the bottom surface 51 of the reflector 5 to face the bottom surface 51. The reflector 5 and diffusion plate 4 constitute a hollow box shape. The diffusion plate 4 corresponds to a cover of the reflector 5 with a box shape. The hollow box includes, for example, a reflecting surface and a diffusion surface.

The light distribution control element 6 is an optical element that changes the light distribution of light emitted from the light sources 7. For example, the light distribution control element 6 is, for example, a condensing lens. The light distribution control element 6 is, for example, a lens partially having a converging property and partially having a diverging property. Here, the converging property is a property of a convex lens. The diverging property is a property of a concave lens. Also, the light distribution control element 6 is, for example, a cylindrical lens.

“Light distribution” refers to a luminous intensity distribution of a light source with respect to space. That is, it refers to a spatial distribution of light emitted from a light source. “Luminous intensity” indicates the degree of intensity of light emitted by a luminous body and is obtained by dividing the luminous flux passing through a small solid angle in a given direction by the small solid angle. “Luminous intensity” refers to a physical quantity indicating how strong light emitted from a light source is.

The light distribution control element 6 is located in the +z axis direction from the light sources 7. The light distribution control element 6 is disposed to cover the light sources 7. The light distribution control element 6 is disposed to surround the light sources 7. In the first embodiment, the light distribution control element 6 surrounds the light sources 7 from the +z axis side.

The light distribution control element 6 is, for example, a rod-shaped optical element extending in the y axis direction. The light distribution control element 6 is, for example, a cylindrical lens.

A cylindrical lens is a lens having a cylindrical refractive surface. A cylindrical lens has curvature in one direction (first direction) but has no curvature in a direction (second direction) perpendicular to the one direction (first direction). When light is incident on a cylindrical lens, convergence or divergence occurs only in one direction. When parallel light is incident on a convex cylindrical lens, the light converges to a line. The line to which the light converges is referred to as a focal line.

In the first embodiment, the first direction is the x axis direction. The second direction is the y axis direction.

The light distribution control element 6 uses, for example, a transparent material, such as acrylic resin (PMMA).

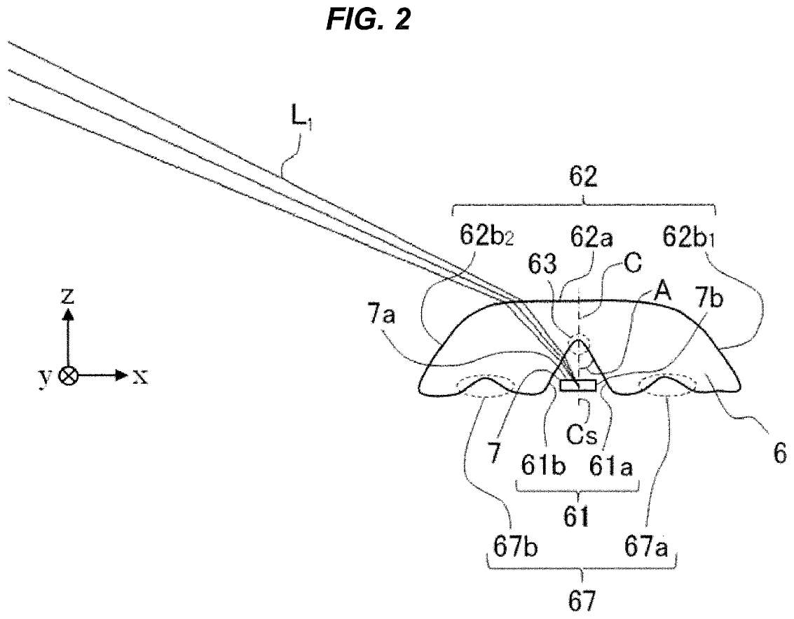

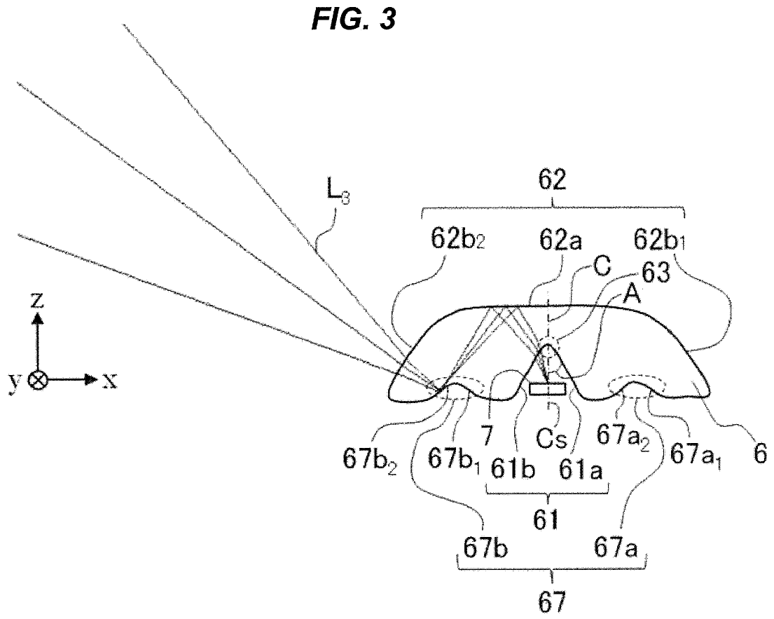

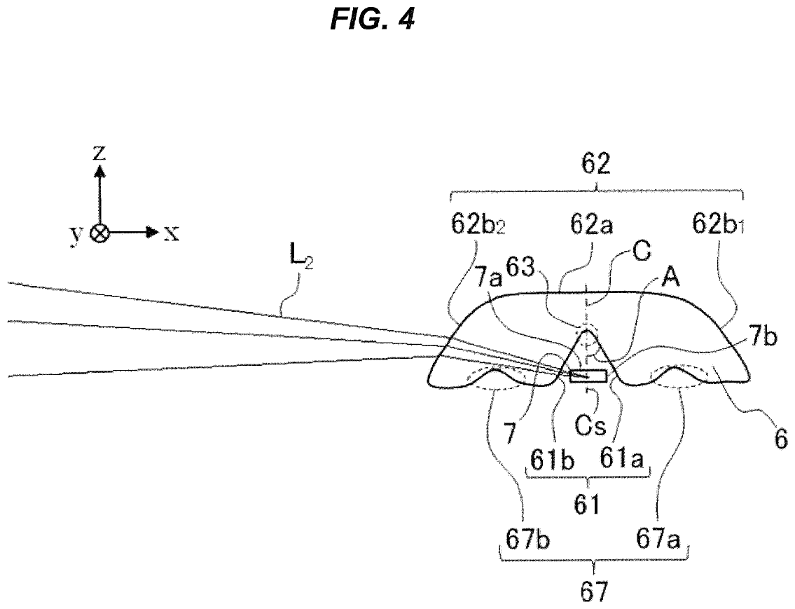

FIGS. 2, 3, and 4 are diagrams each illustrating behavior of light rays emitted from a light source 7 when the light rays pass through the light distribution control element 6. FIG. 2 is a diagram illustrating travel of light rays L₁ in the vicinity of an optical axis C of the light distribution control element 6, the light rays L₁ being part of light rays emitted from the light source 7. FIG. 3 is a diagram illustrating travel of light L₃ reflected by a light emitting surface 62, the light L₃ being part of the light rays L₁ emitted from the light source 7 to the vicinity of the optical axis C. FIG. 4 is a diagram illustrating travel of light rays L₂ making large angles with the optical axis C, the light rays L₂ being part of the light rays emitted from the light source 7.

In the first embodiment, the optical axis C of the light distribution control element 6 is parallel to the z axis.

FIGS. 2, 3, and 4 each illustrate a cross-sectional shape taken in a z-x plane. However, for ease of viewing light rays, hatching of cross-sections is omitted.

The light rays L₁ emitted from the light source 7 to the vicinity of the optical axis C are, for example, light rays that directly reach a light emitting surface 62a from the light source 7. The light rays L₁ are emitted from a light emission surface 7a of the light source 7.

The light rays L₂ making large angles with the optical axis C are, for example, light rays that directly reach light emitting surfaces 62b from the light source 7. The light rays L₂ are emitted from a light emission surface 7b of the light source 7.

The following describes a case where the light distribution control element 6 is a cylindrical lens extending in the y axis direction. The light distribution control element 6 converges or diverges light in a z-x plane.

The light distribution control element 6 includes a light incident surface 61 that receives light rays L emitted from the light source 7. The light distribution control element 6 also includes the light emitting surface 62 that emits the light rays L entering through the light incident surface 61. The light rays L include the light rays L₁, L₂, and L₃.

The light incident surface 61 includes two light incident surfaces 61a and 61b. The light incident surfaces 61a and 61b are surfaces inclined with respect to a y-z plane.

The light incident surfaces 61a and 61b are inclined so that the distance therebetween decreases in the +z direction. The distance between positions on the light incident surface 61 symmetric with respect to the optical axis C decreases in a direction toward the light emitting surface 62a. The distance between the optical axis C and each of the light incident surfaces 61a and 61b decreases in the direction toward the light emitting surface 62a.

As viewed in a z-x plane, the light incident surfaces 61a and 61b form the shape of an isosceles triangle. As viewed in a z-x plane, the light incident surfaces 61a and 61b correspond to the equal sides of the isosceles triangle. As viewed in a z-x plane, an intersection of the light incident surfaces 61a and 61b corresponds to the apex of the isosceles triangle. The light incident surfaces 61a and 61b may be curved surfaces that curve in a z-x plane.

In FIG. 2, a portion (apex portion 63) where the light incident surfaces 61a and 61b meet each other is a curved surface. The apex portion 63 may have, for example, a planar shape parallel to the x-y plane. That is, the apex portion 63 may have, for example, a planar shape parallel to a plane perpendicular to the optical axis C. In this case, in a z-x plane, the light incident surface 61 forms a trapezoidal shape.

In FIGS. 2, 3, and 4, the optical axis C passes through the apex portion 63. The optical axis C passes through an end portion of the light incident surface 61 on the light emitting surface 62a side.

The light incident surfaces 61a and 61b are symmetric with respect to the optical axis C in a z-x plane, for example.

In the first embodiment, the light distribution control element 6 is described as a cylindrical lens. In the light distribution control element 6, the light incident surfaces 61a and 61b form a concave portion having a triangular prism shape. The concave portion has, for example, a groove shape. The concave portion extends in the y axis direction, for example.

The light source 7 is disposed in the concave portion formed by the light incident surface 61. The concave portion is a space surrounded by the light incident surface 61. The concave portion is a space on the −z axis side of the light incident surface 61. The concave portion is a space on a side of the light incident surface 61 opposite to the light emitting surface 62a.

The light emitting surface 62 includes the light emitting surface 62a and light emitting surfaces 62b.

The light emitting surface 62a is located on the +z axis side of the light distribution control element 6. The optical axis C passes through the light emitting surface 62a. Thus, the light emitting surface 62a has an intersection with the optical axis C.

The light emitting surface 62a is, for example, a convex surface projecting in the +z axis direction. In the first embodiment, the light emitting surface 62a has, for example, a cylindrical surface shape. That is, the light emitting surface 62a is a cylindrical surface.

“Cylindrical surface” refers to a cylindrical surface shape, and to a surface having curvature in one direction but having no curvature in a direction perpendicular to the one direction. A cross-sectional shape of a cylindrical surface is not limited to an arc shape.

In the first embodiment, the light emitting surface 62a has curvature in the x axis direction but has no curvature in the y axis direction.

“Optical axis” refers to a straight line passing through a center and a focal point of a lens, a spherical mirror, or the like. In the case of a cylindrical surface, it is defined by a lens shape that is a cross-sectional shape having curvature. In the first embodiment, the optical axis C is defined by the shape of the light emitting surface 62a in a z-x plane. In the first embodiment, “an axis of a cylindrical surface” is different from the optical axis C, and is an axis parallel to the y axis.

The light emitting surfaces 62b are formed at ends of the light emitting surface 62a in the x axis direction. A light emitting surface 62b₁ is formed at an end of the light emitting surface 62a on the +x axis side. A light emitting surface 62b2 is formed at an end of the light emitting surface 62a on the −x axis side.

In a z-x plane, the light emitting surfaces 62b extend from the ends of the light emitting surface 62a in the −z direction. The light emitting surfaces 62b extend from the ends of the light emitting surface 62a toward the light source 7 in a direction of the optical axis C.

The light emitting surfaces 62b are surfaces inclined with respect to a y-z plane. The light emitting surface 62b₁ is rotated counterclockwise relative to a y-z plane as viewed from the −y axis direction. The light emitting surface 62b₂ is rotated clockwise relative to a y-z plane as viewed from the −y axis direction. The light emitting surfaces 62b₁ and 62b₂ are inclined so that the distance therebetween increases in the −z axis direction. Each of the light emitting surfaces 62b₁ and 62b₂ is inclined so that the distance from the optical axis C increases toward the light source 7. Each of the light emitting surfaces 62b₁ and 62b₂ is inclined so that the distance from the optical axis C decreases from the light source 7 toward the light emitting surface 62a. In the first embodiment, the light emitting surfaces 62b₁ and 62b₂ are symmetric with respect to the optical axis C.

The light emitting surfaces 62b have, for example, planar shapes. Alternatively, the light emitting surfaces 62b have, for example, curved surface shapes. For example, the light emitting surfaces 62b have convex shapes. In FIG. 2, the light emitting surfaces 62b have gentle convex shapes.

Light reflecting surfaces 67 are surfaces that reflect the light rays L₃ reflected by the light emitting surface 62a.

For this purpose, the light reflecting surfaces 67 are formed to face the light emitting surface 62a.

The light reflecting surfaces 67 are formed alongside the light incident surface 61 in the x axis direction, in a z-x plane. In a z-x plane, the light reflecting surfaces 67a and 67b are arranged to sandwich the light incident surface 61. The light incident surface 61 is located on the optical axis C. The light reflecting surfaces 67a and 67b are arranged symmetrically with respect to the optical axis C.

In a z-x plane, the light reflecting surface 67a is formed on the +x axis side of the light incident surface 61. The light reflecting surface 67b is formed on the −x axis side of the light incident surface 61. The light reflecting surface 67a is formed on the +x axis side of the light incident surface 61a. The light reflecting surface 67b is formed on the −x axis side of the light incident surface 61b.

The light reflecting surfaces 67 have concave curved surface shapes. The light reflecting surfaces 67 have convex shapes projecting in the +z axis direction as viewed in a z-x plane. The light reflecting surfaces 67 project toward the light emitting surface 62a as viewed in a z-x plane. In FIG. 3, the light reflecting surfaces 67 have gentle concave curved surface shapes.

The light reflecting surfaces 67 have, for example, groove shapes extending in the y axis direction.

A light reflecting surface 67a₁ is a surface of the light reflecting surface 67a on the +x axis side. A light reflecting surface 67a₂ is a surface of the light reflecting surface 67a on the −x axis side. A light reflecting surface 67b₁ is a surface of the light reflecting surface 67b on the +x axis side. A light reflecting surface 67b₂ is a surface of the light reflecting surface 67b on the −x axis side.

The light reflecting surfaces 67 are, for example, light diffusing surfaces. In this case, the light rays L₃ reflected by the light reflecting surfaces 67 are scattered.

The light sources 7 are, for example, light sources using light emitting diodes (referred to below as LED elements). The light sources 7 include, for example, organic electroluminescence light sources, light sources that irradiate phosphor applied on planes with excitation light to cause the phosphor to emit light, and the like. The light sources 7 are, for example, solid-state light sources. In the first embodiment, the light sources 7 are described as using LED elements.

The multiple LED elements (light sources 7) are disposed on the bottom surface 51 of the reflector 5. The LED elements (light sources 7) are arranged in the y axis direction, for example. The light sources 7 are arranged in a direction of an axis of the cylindrical surface as the light emitting surface 62a.

Each light source 7 emits light from a surface on the +z axis side and a side surface. Here, the side surface is a surface joining the surface on the +z axis side and a surface on the −z axis side of the light source 7. The light emission surface 7a is the surface on the +z axis side of the light source 7. The light emission surface 7b is the side surface of the light source 7.

The light emission surface 7a emits the light rays L₁. The light emission surface 7b emits the light rays L₂. The light emission surface 7b is formed around or in the vicinity of the light emission surface 7a. The light emission surface 7b emits the light rays L₂ in a direction perpendicular to a direction (the +z axis direction) in which the light rays L₁ are emitted.

The surface of the light source 7 on the −z axis side is a surface for power supply to the light source 7 or other purposes. Thus, the surface of the light source 7 on the −z axis side is electrically in contact with a circuit board or the like. For example, when the light source 7 has a rectangular parallelepiped shape, the light source 7 has five light emitting surfaces. This LED is also referred to as a CSP-LED (Chip Scale Package).

The light source 7 can have any shape that allows light to be emitted in directions other than that of the mounted surface (the surface of the light source 7 on the −z axis side) of the light source 7. It is sufficient that the light source 7 can emit the light rays L₁ and L₂ in the first embodiment.

The light source 7 has, for example, a column body shape. “Column body” refers to a tubular solid surrounded by two parallel planes and a column surface. The column surface is a curved surface corresponding to a side surface of the column body. The column body includes a prism, a cylinder, and the like. The light source 7 has, for example, a quadrangular prism shape. In another aspect, the light source 7 has, for example, a cylindrical shape. For example, in the case of a quadrangular prism shape, the column surface consists of multiple planes.

The light emission surface 7a corresponds to one plane of the column body shape. The light emission surface 7b corresponds to the column surface of the column body shape.

Of the two planes of the column body shape, at least, the surface corresponding to the light emission surface 7a may be a curved surface. The shape of the side surface in a plane passing through a central axis may be a curved line. For example, the shape of the side surface in a plane perpendicular to a central axis of the column body shape may be a curved line.

The light source 7 has, for example, a frustum shape. “Frustum” refers to a solid figure obtained by removing, from a first cone, a second cone that shares an apex with the first cone, is obtained by reducing the first cone, and is similar to the first cone. The light source 7 has, for example, a truncated pyramid shape. In another aspect, the light source 7 has, for example, a circular truncated cone shape. A frustum has two parallel bases. Each base is referred to as an upper base or a lower base, similarly to the two bases of a trapezoid.

The light emission surface 7a corresponds to one base (the upper base) of the frustum shape. The light emission surface 7b corresponds to a side surface of the frustum shape.

At least, the upper base of the frustum shape may be a curved surface. The shape of the side surface in a plane passing through a central axis may be a curved line. For example, the shape of the side surface in a plane perpendicular to a central axis of the frustum shape may be a curved line.

The light source 7 has, for example, a dome shape. “Dome shape” refers to a shape obtained by horizontally rotating an arch shape about the apex of the arch shape. For example, the dome shape is a hemisphere shape. “Arch shape” refers to a curve shape with its central part projecting upward.

The light source 7 may have a shape obtained by combining a column body shape, a frustum shape, or a dome shape. For example, it may have a shape obtained by putting a dome shape on an upper base portion of a frustum shape.

As described above, the light source 7 is disposed in the concave portion formed by the light incident surfaces 61a and 61b.

An optical axis Cs of the light source 7 is, for example, a normal to the light emission surface 7a of the light source 7 located at a center of the light emission surface 7a. The optical axis Cs is an axis normal to the light emission surface 7a of the light source 7 located at a center of the light emission surface 7a. In the first embodiment, the optical axis Cs of the light source 7 coincides with the optical axis C of the light distribution control element 6.

<Behavior of Light Rays>

The light rays L emitted from the light source 7 enters the light distribution control element 6 through the light incident surface 61. The light rays L reaching the light incident surface 61 is refracted by the light incident surfaces 61a and 61b and enters the light distribution control element 6.

According to Snell's law, the refractive angles of the light rays are greater than the incident angles of the light rays.

As illustrated in FIG. 2, the light rays L₁ emitted toward the +z axis direction side of the light source 7 are refracted at the light incident surfaces 61a and 61b toward the +z axis direction side. The light rays L₁ emitted toward the +z axis direction side of the light source 7 are light rays emitted from the light emission surface 7a of the light source 7 on the +z axis side.

As illustrated in FIG. 4, part of the light rays L₂ emitted from the side surface (light emission surface 7b) of the light source 7 are also refracted at the light incident surfaces 61a and 61b toward the +z axis direction side.

The light rays L travel inside the light distribution control element 6 and then reach the light emitting surface 62.

According to Fresnel equations, when a light ray strikes an interface between media having different refractive indexes, part of the light ray is reflected by the interface, and the other part of the light ray is refracted and transmitted through the interface. The ratio of the light ray reflected by the interface increases as the angle at which the light ray strikes the interface increases. Further, when a light ray strikes the interface at an angle not less than a given angle, all the light ray is reflected without passing through the interface.

Part of the light rays L traveling inside the light distribution control element 6 are emitted from the light emitting surface 62a.

The light emitting surface 62a is a surface of the light distribution control element 6 on the +z axis side. The light emitting surface 62a has, for example, a convex shape. In FIG. 2, the light emitting surface 62a has a gently curved convex shape.

As illustrated in FIG. 2, the light rays I₁ are refracted by the light emitting surface 62a in directions such that the angles of the light rays L₁ with respect to the optical axis C increase.

As illustrated in FIG. 3, part of the light rays L₁ traveling inside the light distribution control element 6 are reflected by the light emitting surface 62a. The light rays L₃ reflected by the light emitting surface 62a travel in the −z axis direction.

The light rays L₃ are reflected by the light emitting surface 62a at angles (reflection angles) equal to the angles (incident angles) at which they are incident on the light emitting surface 62. The incident angle and reflection angle of a reflected light ray are equal to each other (the law of reflection). The incident angle and reflection angle are defined as angles between the traveling directions of the respective light rays and the normal to the interface.

The light rays L₃ are reflected by the light emitting surface 62a in the −z direction at angles equal to the angles at which they are incident on the light emitting surface 62a.

Part of the light rays L₃ reflected by the light emitting surface 62a and traveling inside the light distribution control element 6 are reflected by the light reflecting surfaces 67 in the +z direction. The light rays L₃ reflected by the light reflecting surfaces 67 travel in the +z direction.

When the light reflecting surfaces 67 are light diffusing surfaces, part of the light rays L₃ reflected by the light emitting surface 62a and traveling inside the light distribution control element 6 are diffused and reflected in the +z direction by the light reflecting surfaces 67. The light rays L₃ reflected by the light reflecting surfaces 67 are diffused light. The light rays L₃ reflected by the light reflecting surfaces 67 travel in the +z direction.

The light rays L₃ reflected by the light reflecting surfaces 67 travel inside the light distribution control element 6, and then are emitted from the light emitting surfaces 62b. The light rays L₃ reflected by the light reflecting surfaces 67 are combined with the light rays L₂. This increases the amount of light emitted from the light emitting surfaces 62b.

The light rays L₃ reflected by the light emitting surface 62a are reflected by the light reflecting surface 67a₁ or 67b₂ and emitted from the light emitting surfaces 62b. The light rays L₃ reflected by the light emitting surface 62a are reflected by the light reflecting surface 67a₁ and emitted from the light emitting surface 62b₁. The light rays L₃ reflected by the light emitting surface 62a are reflected by the light reflecting surface 67b₂ and emitted from the light emitting surface 62b₂.

The light rays L₃ reflected by the light reflecting surfaces 67 are refracted in the +z axis direction by the light emitting surfaces 62b.

The light emitting surfaces 62b have, for example, convex shapes. Thus, the directions in which the light rays L₂ and L₃ reaching the light emitting surfaces 62b are refracted depend on the positions on the light emitting surfaces 62b. The light rays L₂ and L₃ emitted from the light emitting surfaces 62b travel in the +z direction while spreading. The light rays L₂ and L₃ then reach a peripheral region of the opening 53.

However, in some cases, part of the light rays L₂ and L₃ emitted from the light emitting surfaces 62b travel in the −z direction while spreading. The light rays L₂ and L₃ traveling in the −z direction are reflected by the bottom surface 51 or side surfaces 52 of the reflector 5. The light rays L₂ and L₃ reflected by the bottom surface 51 or side surfaces 52 travel in the +z direction. The light rays L₂ and L₃ emitted from the light emitting surfaces 62b reach the diffusion plate 4 (opening 53). The light rays L₂ and L₃ reach the peripheral region of the opening 53.

Due to refraction at the light incident surface 61, refraction at the light emitting surface 62a, reflection at the light emitting surface 62a, reflection at the light reflecting surfaces 67, or refraction at the light incident surfaces 62b, the light rays L emitted from the light source 7 travel in a direction in which the surface light source device 200 radiates planar light. In the first embodiment, the direction in which the surface light source device 200 radiates planar light is a direction toward the opening 53. The direction in which the surface light source device 200 radiates planar light is the +z axis direction. The opening 53 is the light emitting surface of the surface light source device 200.

The light rays L₁, L₂, and L₃ emitted from the light distribution control element 6 reach the diffusion plate 4, for example. The light rays L₁, L₂, and L₃ reaching the diffusion plate 4 are diffused and emitted from the surface light source device 200. In the first embodiment, the diffusion plate 4 is the light emitting surface of the surface light source device 200.

The light distribution control element 6 has a function of changing the light distribution of the light source 7 into the brightness distribution on the light emitting surface of the surface light source device 200.

In the light distribution control element 6, the spread of the light rays L₁, L₂, and L₃ emitted from the light distribution control element 6 can be controlled by adjusting an inclination angle A of the light incident surface 61, a curvature of the apex portion 63, the shape of the curved surface as the light emitting surface 62a, inclination angles of the light emitting surfaces 62b, the shapes of the curved surfaces as the light emitting surfaces 62b, inclination angles of the light reflecting surfaces 67a₁ and 67b₂, the shapes of the curved surfaces as the light reflecting surfaces 67a₁ and 67b₂, or the like. The inclination angle A is an angle formed by the optical axis C and each of the light incident surfaces 61a and 61b in a z-x plane.

Part of the light rays L₁, L₂, and L₃ reaching the diffusion plate 4 are reflected and travel inside the reflector 5. The light rays L₁, L₂, and L₃ traveling inside the reflector 5 are reflected by the bottom surface 51 or side surfaces 52 of the reflector 5, and reach the diffusion plate 4 again.

Light passing through the diffusion plate 4 is diffused by the diffusion plate 4. The light that has passed through the diffusion plate 4 is planar illumination light with improved uniformity.

The light passing through the diffusion plate 4 is radiated toward the back surface 1b of the liquid crystal panel 1. This illumination light passes through the optical sheet 3 and optical sheet 2, and irradiates the back surface 1b of the liquid crystal panel 1. The back surface 1b is a surface of the liquid crystal panel 1 on the −z axis direction side.

As described above, the light distribution control element 6 has been described as a rod-shaped optical element, for example. However, the light distribution control element 6 is not limited to a rod-shaped optical element. Even when a light distribution control element 6 is mounted for each light source 7, the same effects can be obtained. The light distribution control element 6 may have a shape rotationally symmetric about the optical axis C, or other shapes. The light distribution control element 6 has the shape of a solid of revolution symmetric about the optical axis C. A solid of revolution is a solid figure obtained by rotating a curve in a plane about a straight line in the plane.

In this case, the light incident surface 61 has a circular cone shape, circular truncated cone shape, or the like. The apex portion 63 may have a curved surface shape, a planar shape, or the like.

However, when the light distribution control element 6 is rod-shaped, the light distribution control element 6 can be produced by extrusion molding. Typically, in a direct backlight device, one lens is mounted for each LED element (light source 7). However, one rod-shaped light distribution control element 6 is sufficient for the multiple LED elements (light sources 7) arranged in a row.

Thus, by forming the light distribution control element 6 to have a rod shape, it is possible to reduce the number of light distribution control elements 6. Further, when a lens (light distribution control element 6) is mounted for each LED element (light source 7), it is necessary to mount the individual light distribution control elements 6 on a substrate on which the LED elements (light sources 7) are arranged. However, in the light distribution control element 6 of the first embodiment, since the single light distribution control element 6 is mounted for the multiple LED elements (light sources 7) arranged in a row, the work of mounting the light distribution control element 6 is easy.

Further, it is conceivable to employ an optical element that needs to be positioned in the x-y plane relative to the LED elements (light sources 7), such as a lens array that is a single optical element including multiple lenses. However, a mold for the optical element needs to be changed in accordance with increase or decrease in the number of LED elements (light sources 7). Thus, the versatility for different specifications of the surface light source device is low.

In the light distribution control element 6 according to the first embodiment, a mold for the light distribution control element 6 need not be changed in accordance with increase or decrease in the number of LED elements (light sources 7). Thus, the light distribution control element 6 is high in versatility for different specifications of the surface light source device 200. By just changing the number of LED elements (light sources 7), the brightness of the surface light source device 200 can be adjusted. Thus, an optimum number of LED elements (light sources 7) can be arranged.

Further, when the light distribution control element 6 is produced by extrusion molding, its length can be freely changed. Thus, for example, the same mold can be used for liquid crystal display apparatuses 100 having different sizes.

From the above, in the surface light source device 200 of the first embodiment, even when the light sources 7 are arranged in a partial region, the light rays L₁, L₂, and L₃ emitted from the light distribution control element 6 can be directed toward the light emitting surface (diffusion plate 4) of the surface light source device 200. The traveling directions of the light rays L₁, L₂, and L₃ are changed by the light distribution control element 6 to directions toward the opening 53 (light emitting surface of the surface light source device 200). Thus, the surface light source device 200 can provide a planar light source having improved uniformity and less dependence on the shape of the reflector 5.

To reduce the number of light sources 7, it is possible to arrange the light sources 7 in a row. For example, the multiple light sources 7 are arranged in, for example, a central part in a direction (the x axis direction) of a short edge of the backlight device 200, along a direction (the y axis direction) of a long edge of the backlight device 200, as viewed from the display surface side. By using the rod-shaped light distribution control element 6, it is possible to direct the light distribution of the light sources 7 to the light emitting surface (diffusion plate 4) of the surface light source device 200 with a simple configuration.

Although the light distribution control element 6 has been described as using a transparent material, it is also possible to employ, for example, a material containing a diffusing material. When light rays are incident on the diffusing material, the light rays are scattered and have their traveling directions changed. Thus, the light rays L traveling inside the light distribution control element 6 have their traveling directions changed to random directions. The light rays L whose traveling direction have been changed reach the light emitting surface 62 of the light distribution control element 6. This enables a wide area to be irradiated with light emitted from the light distribution control element 6.

It is also possible to form an irregular (or concavo-convex) shape on the light incident surface 61, light emitting surface 62, or light reflecting surfaces 67 of the light distribution control element 6, using a transparent material. For example, it is possible to provide a fine irregular shape to the light incident surface 61, light emitting surface 62, or light reflecting surfaces 67.

The irregular shape formed on the light incident surface 61, light emitting surface 62, or light reflecting surfaces 67 randomly changes the traveling directions of light rays. Thus, it is possible to illuminate a wide area with light emitted from the light distribution control element 6.

Like these, diffusing light causes the light to travel in random directions. This can reduce bright lines. “Bright lines” refers to linear bright regions formed on a light emitting surface of a surface light source device.

The array of the multiple light sources 7 may cause brightness unevenness on the light emitting surface of the surface light source device. In this case, the brightness unevenness can be reduced by diffusing light. The difference between bright portions and dark portions can be reduced.

The irregular shape need not be formed on the entire regions of the light incident surface 61, light emitting surface 62, and light reflecting surfaces 67. For example, the irregular shape may be formed only on the light incident surface 61. For example, the irregular shape may be formed only on a partial region of the light emitting surface 62. For example, the irregular shape may be formed only on a partial region of the light reflecting surfaces 67. The irregular shape may be formed on a partial region of the light incident surface 61, light emitting surface 62, or light reflecting surfaces 67.

The irregular shape need not have uniform roughness over the entire region. For example, the irregular shape on the light incident surface 61 may be smaller than the irregular shape on the light emitting surface 62 or light reflecting surfaces 67.

The degree of diffusion of light by the diffusing material or irregular shape is preferably less than the degree of refraction of light rays by the light incident surface 61, the degree of refraction of light rays by the light emitting surface 62, or the degree of reflection of light rays by the light reflecting surfaces 67. This is because the diffusing material or irregular shape dominantly affects the light distribution of light emitted from the light distribution control element 6, which makes it difficult to adjust the light distribution by design.

The light distribution of the light is directed to the light emitting surface (diffusion plate 4) of the surface light source device 200 by refraction or reflection based on the shape of the light distribution control element 6. Thus, increase in factors of light diffusion may lead to a situation where only a region near the light sources 7 is bright and a region farther from the light sources 7 is darker.

### First Modification Example

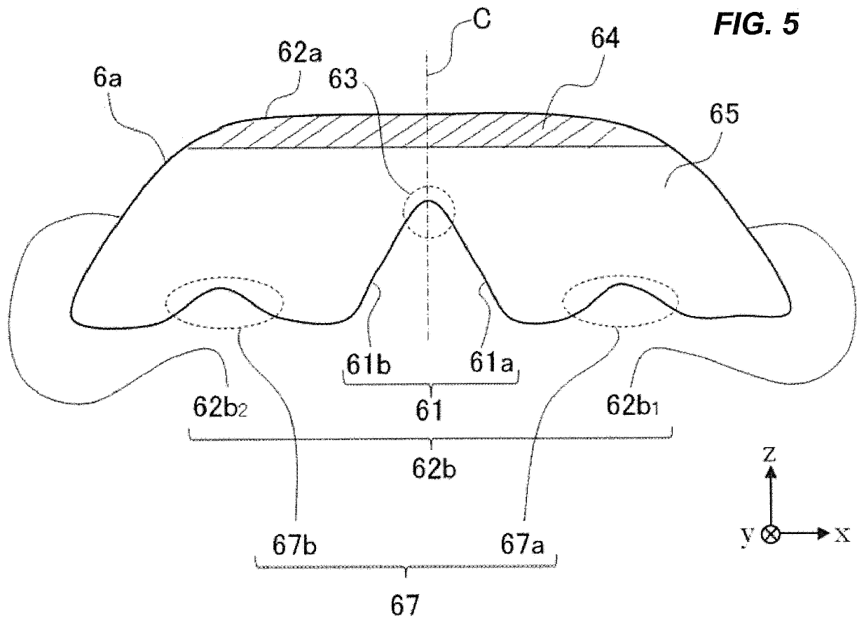

FIG. 5 is a diagram illustrating a configuration of a light distribution control element 6a of a first modification example.

The material of the light distribution control element 6 has been described as a transparent material. However, for example, as illustrated in FIG. 5, the light distribution control element 6a may have a multi-layer structure using a material 64 and a transparent material 65.

A portion having the light emitting surface 62a of the light distribution control element 6a is formed of the material 64. A portion on the −z axis side of the portion formed of the material 64 is formed of the transparent material 65. A portion on the light incident surface 61 side of the portion formed of the material 64 is formed of the transparent material 65.

Thus, light entering through the light incident surface 61 passes through the portion of the transparent material 65, and then passes through the portion of the material 64 and reaches the light emitting surface 62a.

The material 64 may be, for example, a material including a diffusing material. The material 64 may be, for example, a transparent material having a refractive index different from that of the transparent material 65.

When the light distribution control element 6a is produced by extrusion molding, it can be formed using multiple materials.

The light distribution can be controlled by partially changing the material as above.

It is not limited to the multi-layer structure illustrated in FIG. 5. It is possible to arrange arbitrary materials at arbitrary positions in accordance with the light distribution.

### Second Modification Example

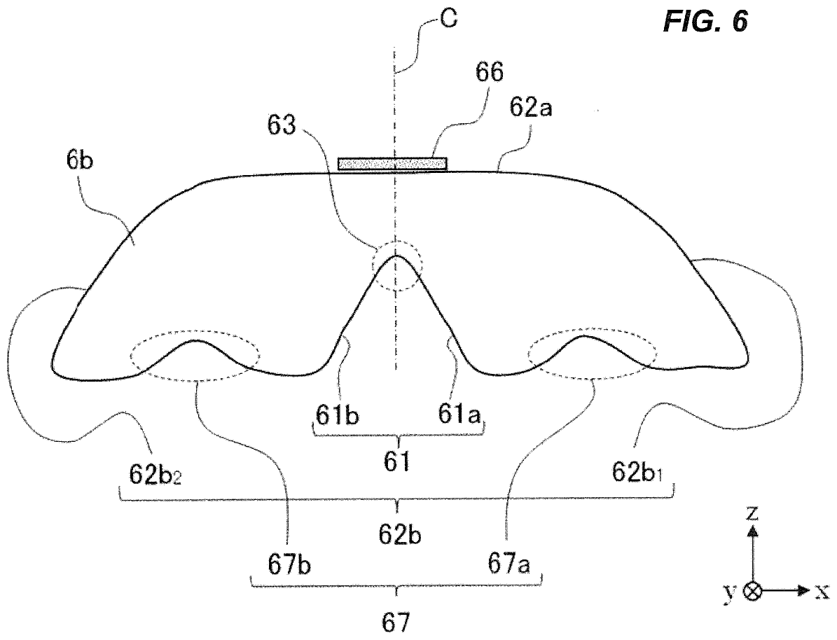

FIG. 6 is a diagram illustrating a configuration of a light distribution control element 6b of a second modification example.

As illustrated in FIG. 6, for example, a light diffusing element 66 may be disposed on the light emitting surface 62 of the light distribution control element 6 illustrated in FIG. 2. In FIG. 6, the light diffusing element 66 is sheet-like. The light diffusing element 66 is disposed on the optical axis C. The light diffusing element 66 is disposed on the light emitting surface 62a of the light distribution control element 6b.

A Light ray traveling on the optical axis C of the light distribution control element 6b may travel straight without being refracted at the light incident surface 61 and light emitting surface 62a. In this case, it appears as a bright line on the display surface. By disposing the light diffusing element 66 on the optical axis C, it is possible to suppress the bright line and improve brightness uniformity.

It is also possible to form an irregular (or concavo-convex) surface in a region of the light emitting surface 62a through which the optical axis C passes, instead of the light diffusing element 66. For example, when the light distribution control element 6a is produced by extrusion molding, it is possible to form grooves having an irregular (or concavo-convex) shape in a z-x plane and extending in the y axis direction.

### Third Modification Example

For example, a light reflecting element may be disposed on a region on the optical axis C of the light emitting surface 62a of the light distribution control element 6 illustrated in FIG. 2. For example, it is possible to replace the light diffusing element 66 illustrated in FIG. 6 with a light reflecting element.

When the number of light sources 7 is small, regions between adjacent pairs of the light sources 7 are noticeable as dark portions. In this case, a light reflecting element is disposed on a region on the optical axis C of the light emitting surface 62a to reflect light in the −z axis direction. This reflection may be diffuse reflection.

A light reflecting element may be disposed at a position located in the +z axis direction from each light source 7. Light reflected by the light reflecting elements travels in the y axis direction. The light reflected by the light reflecting elements is reflected by a substrate on which the light distribution control element 6 is mounted. In FIG. 1, the substrate on which the light distribution control element 6 is mounted is the bottom surface 51 of the reflector 5. Then, the light reflected by the light reflecting elements is emitted from regions of the light emitting surface 62a between adjacent pairs of the light reflecting elements.

This reflection of light spreads the light in the y axis direction. This spreads the light to spaces between adjacent pairs of the light sources 7, thereby making the dark portions unnoticeable.

With a simple configuration like these, it is possible to improve uniformity of the planar light.

From the above, the surface light source device 200 of the first embodiment can provide a brightness distribution having improved uniformity with a small number of light sources 7 by use of the light distribution control element 6, which is simple and high in versatility.

### Fourth Modification Example

In general, a surface-emitting light source (surface light source) can be considered as a point light source when a lens is large. When a light source cannot be considered as a point light source, the sensitivity to variation from a design value of a lens surface is high. In the case of a surface light source, a change in the traveling direction of a light ray in response to a change in the shape of a lens surface is larger than in the case of a point light source. The higher the sensitivity of a lens surface, the tighter the tolerance of the lens surface. A variation from a design value of a lens surface occurs, for example, during molding of the lens.

When planar light is formed by arranging circular lenses, a brightness distribution is formed by superposition of light from the lenses. Thus, even when sensitive lenses are used, unevenness in the brightness distribution is reduced by superposition of light from adjacent light sources.

However, in the case of a cylindrical lens, for example, the single lens determines the light distribution of multiple light sources arranged in a longitudinal direction of the lens. For example, an irregular shape extending in the longitudinal direction of the cylindrical lens causes unevenness in the brightness distribution. This brightness distribution unevenness is not reduced by superposition of light from adjacent light sources.

The irregular shape extending in the longitudinal direction of the cylindrical lens is formed, for example, during production of a mold for injection molding and transferred onto the cylindrical lens. In another case, the irregular shape extending in the longitudinal direction of the cylindrical lens is formed, for example, during extrusion molding.

For example, when a cross-sectional shape of the cylindrical lens has a variation not less than 0.05 mm from a designed value, a dark line or a bright line may occur on the brightness distribution. The cross-section here is a cross-section in a z-x plane. When it is assumed that a tolerance range of an extrusion-molded lens is at least about ±0.1 mm, it is difficult to improve uniformity of light with the shape of the lens surface.

A surface light source device 210 according to a fourth modification example uses light rays L₄ diffused at the light incident surface 61 of a light distribution control element 6c and light rays L₁, L₂, and L₃ transmitted without being diffused. Thereby, the surface light source device 210 can suppress reduction in brightness distribution uniformity due to variation in accuracy of the lens surface.

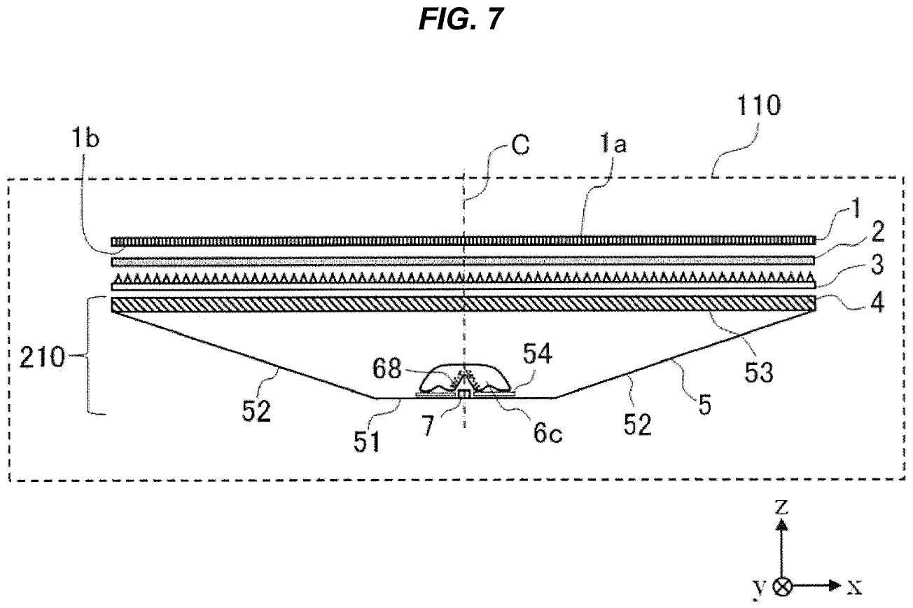

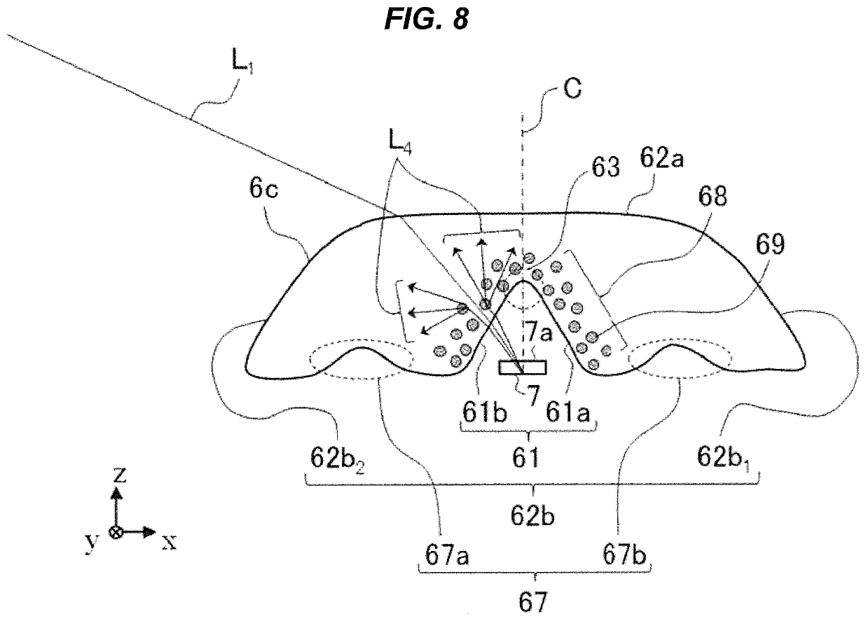

FIG. 7 is a configuration diagram schematically illustrating a configuration of a liquid crystal display apparatus 110 (including the surface light source device 210) according to the fourth modification example. FIGS. 8, 9, and 10 are diagrams each illustrating behavior of light rays emitted from a light source 7 when the light rays pass through the light distribution control element 6c.

The liquid crystal display apparatus 110 differs from the liquid crystal display apparatus 100 in having the light distribution control element 6c and a reflecting member 54.

The light distribution control element 6c differs from the light distribution control element 6 in having a diffusing layer 68. Otherwise, the light distribution control element 6c is the same as the light distribution control element 6.

The light distribution control element 6c includes the light incident surface 61 that receives light rays L emitted from the light sources 7. Further, the light distribution control element 6c includes the diffusing layer 68 for diffusing the light rays L entering through the light incident surface 61.

The light distribution control element 6c includes the diffusing layer 68 at the incident surface 61. The diffusing layer 68 diffuses the incident light. In the fourth modification example, the diffusing layer 68 is formed on an inner side of the incident surface 61.

The diffusing layer 68 is preferably formed at the light incident surface 61 rather than at, for example, the light emitting surface 62.

In the light distribution control element 6c, a refraction angle at the light emitting surface 62 is greater than a refraction angle at the light incident surface 61. When a light ray is refracted at an interface, the refraction angle is an angle made by the traveling direction of the light ray and a normal to the interface. A refraction angle at the light incident surface 61 is an angle made by a normal to the light incident surface 61 and a light ray traveling in the light distribution control element 6c. A refraction angle at the light emitting surface 62 is an angle made by a normal to the light emitting surface 62 and a light ray emitted from the light distribution control element 6c.

Thus, the sensitivity of the traveling direction of a light ray with respect to the tolerance of the surface shape of the light emitting surface 62 is higher than the sensitivity of the traveling direction of a light ray with respect to the tolerance of the surface shape of the light incident surface 61. A change in the traveling direction of a light ray in response to a change in the surface shape of the light emitting surface 62 is larger than a change in the traveling direction of a light ray in response to a change in the surface shape of the light incident surface 61.

If the diffusing layer 68 is provided at the light emitting surface 62, a light distribution change is more likely to occur due to variation in the shape of the light emitting surface 62, variation in the thickness of the diffusing layer, or the like. Thus, the quality control during production needs to be tightened.

Further, the area of the light emitting surface 62 is larger than that of the light incident surface 61. Thus, the amount of diffusing material (particles 69) used for the diffusing layer 68 becomes larger. This may lead to an increase in cost.

The diffusing layer 9 is, for example, a layer including the particles 69. The particles 69 have a refractive index different from that of the transparent material used for the light distribution control element 6c. For example, silicone particles, acrylic particles, polycarbonate particles, or the like are used for the particles 69.

To obtain high diffusibility with a small amount of particles 69, it is preferable to use particles having small particle diameters (or sizes) as the particles 69. The particles 69 have particle diameters of 1 μm or more and 100 μm or less, for example. More preferably, the particles 69 have particle diameters of 1 μm or more and 50 μm or less, for example. Still more preferably, the particles 69 have particle diameters of 1 μm or more and 10 μm or less, for example.

The particles 69 preferably have, for example, spherical shapes. The particles 69 may have, for example, random shapes. The random shapes of the particles 69 are obtained, for example, by pulverizing spherical particles 69.

The particles 69 included in the diffusing layer 9 have the same size, for example. The particles 69 included in the diffusing layer 9 may have different sizes. The particles 69 have the same shape, for example. The particles 69 may have different shapes, for example.

In FIGS. 8, 9, and 10, the diffusing layer 68 is formed in the vicinity of the shape of the isosceles triangle of the light incident surfaces 61a and 61b, as viewed in a z-x plane. The diffusing layer 68 is formed entirely around the light incident surfaces 61a and 61b, for example. The diffusing material (particles 69) is distributed at the light incident surface 61 in the form of a layer.

The diffusing layer 68 may be formed partially around the light incident surfaces 61a and 61b. For example, the diffusing layer 9 may be formed only in the apex portion 63. The apex portion 63 is a portion at the apex of the shape of the isosceles triangle of the light incident surfaces 61a and 61b.

For example, the diffusing layer 68 is formed along the shape of the light incident surface 61 to have uniform thickness. The diffusing layer 68 is also formed so that the concentration of the particles 69 is uniform.

For example, in view of the intensity distribution of light from the light sources 7, the diffusing layer 68 may be formed along the shape of the light incident surface 61 to have non-uniform thickness. The diffusing layer 68 may be formed so that the concentration of the particles 69 is non-uniform, for example.

The following describes a case where the light distribution control element 6c is a cylindrical lens extending in the y axis direction. The light distribution control element 6c converges or diverges light in a z-x plane.

In FIGS. 8, 9, and 10, the light rays L₁, L₂, and L₃ travel without being diffused by the diffusing layer 68. On the other hand, the light rays L₄ are diffused by the diffusing layer 68.

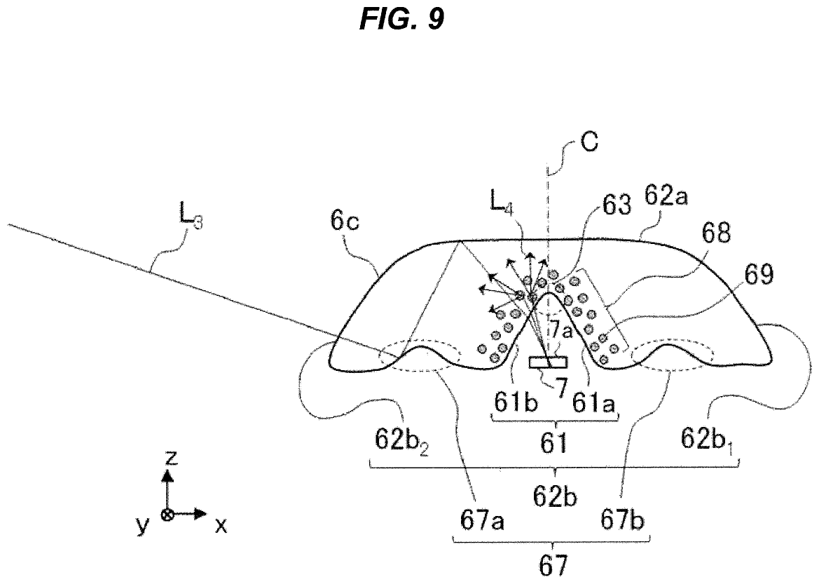

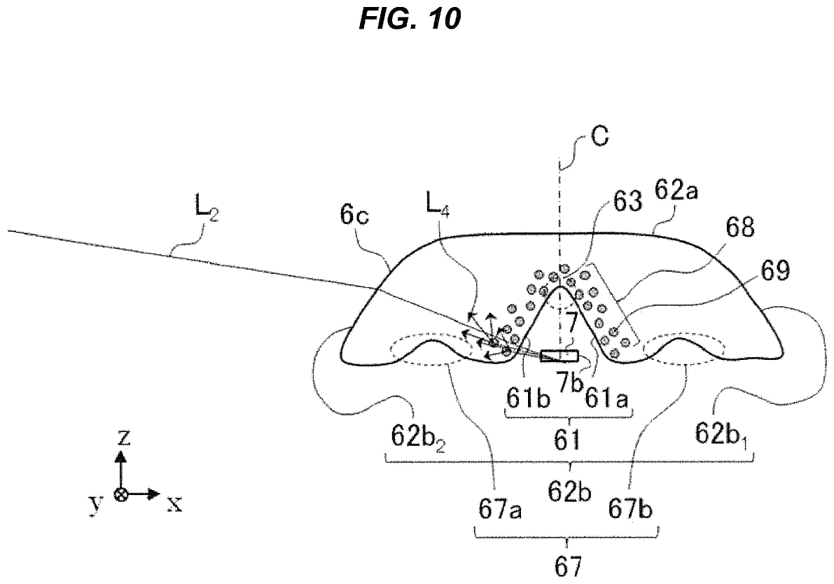

FIG. 8 is a diagram illustrating travel of the light rays L₁ in the vicinity of the optical axis C of the light distribution control element 6c, the light rays L₁ being part of light rays emitted from the light source 7. FIG. 9 is a diagram illustrating travel of the light rays L₃ reflected by the light emitting surface 62, the light rays L₃ being part of the light rays L₁ emitted from the light source 7 to the vicinity of the optical axis C. FIG. 10 is a diagram illustrating travel of the light rays L₂ making large angles with the optical axis C, the light rays L₂ being part of the light rays emitted from the light source 7. In each of FIGS. 8, 9, and 10, the light rays L₄ are light rays diffused by the diffusing layer 68.

In the fourth modification example, the optical axis C of the light distribution control element 6c is parallel to the z axis.

FIGS. 8, 9, and 10 each illustrate a cross-sectional shape taken in a z-x plane. However, for ease of viewing light rays, hatching of cross-sections is omitted.

The light rays L₁ emitted from the light source 7 to the vicinity of the optical axis C are light rays that pass through the diffusing layer 68 without being diffused and reach the light emitting surface 62a, for example. The light rays L₁ are emitted from the light emission surface 7a of the light source 7.

The light rays L₂ making large angles with the optical axis C are, for example, light rays that pass through the diffusing layer 68 without being diffused and directly reach the light emitting surfaces 62b. The light rays L₂ are emitted from the light emission surface 7b of the light source 7.

The light rays L emitted from the light source 7 enter the light distribution control element 6c through the light incident surface 61. The light rays L reaching the light incident surface 61 are refracted by the light incident surfaces 61a and 61b and enter the light distribution control element 6c.

The light rays L₄ reach the diffusing layer 68 after being refracted by the light incident surfaces 61a and 61b.

While traveling in the diffusing layer 68, the light rays L₄ pass through the particles 69. Based on the sizes or shapes of the particles 69, the light rays L₄ are scattered due to Mie scattering. The thicker the diffusing layer 68, the more the light lays L₄ are scattered.

However, increasing the diffused light L₄ too much decreases the amount of light on the periphery of an irradiation region. Thus, the thickness of the diffusing layer 68 is preferably not more than two-thirds of the shortest distance between the light incident surface 61 and the light emitting surface 62.

### Fifth Modification Example

An image display apparatus increases the lightness difference of a displayed image by increasing the brightness difference between bright portions and dark portions, for example. The brightness difference in the display surface can be increased by increasing the maximum brightness. Thereby, the image display apparatus can clearly display an image.

In many displayed images, the upper side of the display surface 1a is bright like, for example, the sun, sky, or the like. On the other hand, in Patent Literature 1, the light sources are arranged to provide uniform brightness or illuminance. Thus, in the configuration described in Patent Literature 1, it is difficult to increase the lightness difference of a displayed image.

In a surface light source device 220 according to a fifth modification example, the light sources 7 are arranged to brighten the upper side (+x axis side) of the display surface 1a of a liquid crystal display apparatus 120. Thereby, when displaying an image including the sun, sky, or the like, the liquid crystal display apparatus 120 can increase the lightness difference of the image.

The surface light source device 220 according to the fifth modification example can display an image with a large lightness difference.

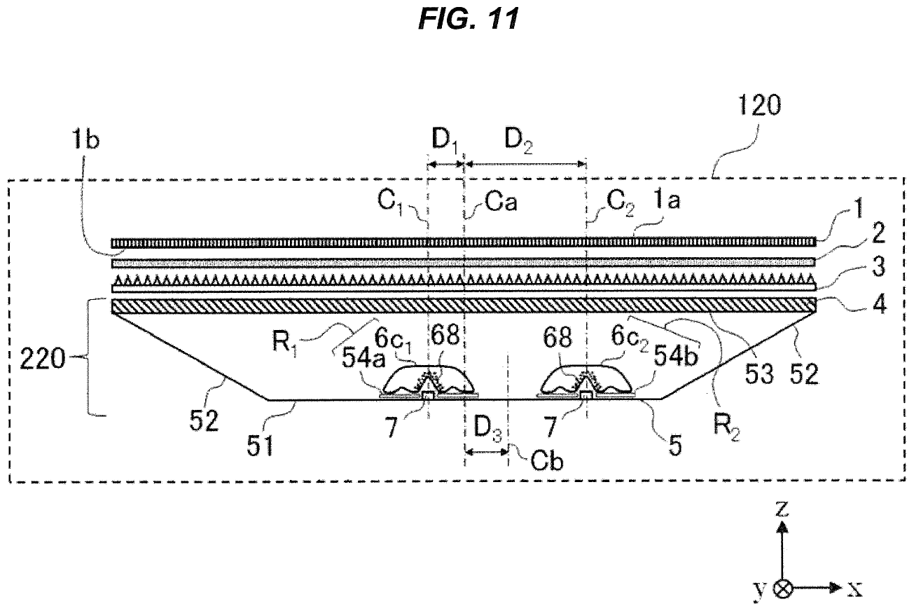

FIG. 11 is a configuration diagram schematically illustrating a configuration of the liquid crystal display apparatus 120 (including the surface light source device 220) according to the fifth modification example

The liquid crystal display apparatus 120 differs from the liquid crystal display apparatuses 100 and 110 in having two light distribution control elements 6c and two reflecting members 54. The liquid crystal display apparatus 120 may include the light distribution control elements 6, 6a, or 6b, instead of the light distribution control elements 6c. The reflecting members 54 may be omitted.

In FIG. 11, the light distribution control elements 6c and reflecting members 54 are collectively referred to as rods. A rod R₁ includes a light distribution control element 6c₁ and a reflecting member 54a. A rod R₂ includes a light distribution control element 6c₂ and a reflecting member 54b. When the reflecting members 54 are omitted, the rods R₁ and R₂ are the light distribution control elements 6c₁ and 6c₂.

In the liquid crystal display apparatus 120, the +x axis side is an upper part of the screen. The optical axes C of the surface light source devices 200 and 210 are located at centers of the surface light source devices 200 and 210 in the x axis direction. The optical axes C of the light distribution control elements 6, 6a, and 6b are located at the centers of the surface light source devices 200 and 210 in the x axis direction.

In the surface light source device 220, optical axes C₁ and C₂ are not located at a center of the surface light source device 220 in the x axis direction. In FIG. 11, the center of the surface light source device 220 in the x axis direction is indicated by a center position Ca.

The rod R₁ is disposed, for example, on the −x axis side of the center position Ca. The rod R₁ is disposed on the lower side of the center of the surface light source device 220. The rod R₂ is disposed, for example, on the +x axis side of the center position Ca. The rod R₂ is disposed on the upper side of the center of the surface light source device 220.

The rods R₁ and R₂ are arranged in a direction in which the light distribution control elements 6c₁ and 6c₂ have curvature. The light distribution control elements 6c₁ and 6c₂ are arranged in the direction in which the light distribution control elements 6c₁ and 6c₂ have curvature. Here, the light distribution control elements 6c₁ and 6c₂ are cylindrical lenses.

Here, it is assumed that a distance between the optical axis C₁ of the rod R₁ and the center position Ca is a distance D₁. It is assumed that a distance between the optical axis C₂ of the rod R₂ and the center position Ca is a distance D₂. In the surface light source device 220, the distance D₁ is less than the distance D₂ (2/1<D₂).

The rod R₁ may be disposed on the +x axis side of the center position Ca.

The surface light source device 220 preferably includes two or more rods R. The rod R₂ is disposed on the +x axis side of the center position Ca. This increases the brightness in an upper part of the light emitting surface of the surface light source device 200. However, the amount of light in a lower part of the light emitting surface of the surface light source device 220 decreases.

The rod R₁ is disposed on the −x axis side of the center position Ca. This can increase the amount of light in the lower part of the light emitting surface of the surface light source device 220. However, to increase the brightness in a central part and the upper part of the light emitting surface of the surface light source device 220 rather than the amount of light in the lower part of the light emitting surface of the surface light source device 220, the rod R₁ is disposed near the center position Ca. In FIG. 11, the light emitting surface of the surface light source device 220 is the diffusion plate 4.

The light distribution control elements 6c are disposed to extend in a horizontal direction of the liquid crystal display apparatus 120. A center position Cb between the multiple light control elements 6c₁ and 6c₂ in a vertical direction is located above (on the +x axis direction side of) the center position Ca. In the fifth modification example, the center position Ca coincides with a center position of the liquid crystal panel 1 in the vertical direction. Thus, the center position Cb between the multiple light control elements 6c₁ and 6c₂ in the vertical direction is located above the center position (center position Ca) of the liquid crystal panel 1 in the vertical direction. In FIG. 11, a distance between the center position Cb and the center position (center position Ca) of the liquid crystal panel 1 in the vertical direction is a distance D₃.

With the above configuration, the surface light source device 220 of the fifth modification example can increase the brightness in the central part and upper part of the light emitting surface. Then, the surface light source device 220 can obtain a brightness distribution suitable for commonly displayed images. The surface light source device 220 can increase lightness differences of commonly displayed images. Then, the surface light source device 220 can clearly display images.

The above-described embodiments may use terms, such as “parallel” or “perpendicular”, indicating the positional relationships between parts or the shapes of parts. These terms are intended to include ranges taking account of manufacturing tolerances, assembly variations, or the like. Thus, recitations in the claims indicating the positional relationships between parts or the shapes of parts are intended to include ranges taking account of manufacturing tolerances, assembly variations, or the like.

Further, although the embodiments of the present invention have been described as above, the present invention is not limited to these embodiments.

Based on the above embodiments, contents of the invention will be described below as Appendixes (1) and (2). In Appendixes (1) and (2), numbering is made independently. Thus, for example, Appendixes (1) and (2) each include “Appendix 1.”

It is possible to combine features in Appendix (1) and features in Appendix (2).

<Appendix (1)>

<Appendix 1>

A surface light source device comprising:

at least one light source to emit light; and

a light distribution control element to receive the light and change a light distribution of the received light, wherein

the light includes a first light ray and a second light ray;

the at least one light source includes:
a first light emission surface to emit the first light ray; and
a second light emission surface to emit the second light ray in a direction perpendicular to a direction in which the first light ray is emitted, the second light emission surface being formed in a vicinity of the first light emission surface;

the light distribution control element includes:
a first light emitting surface formed at a position through which an optical axis of the light distribution control element passes, the first light emitting surface being a surface at which the first light ray arrives;
a second light emitting surface disposed at an end of the first light emitting surface and formed to extend toward the at least one light source in a direction of the optical axis, the second light emitting surface being a surface at which the second light ray arrives; and
a light reflecting surface disposed at a position facing the first light emitting surface, the light reflecting surface reflecting, toward the second light emitting surface, the first light ray reflected by the first light emitting surface;

the second light emitting surface is inclined so that a distance between the second light emitting surface and the optical axis decreases from the at least one light source toward the first light emitting surface; and

the light reflecting surface has a convex shape projecting toward the first light emitting surface.

<Appendix 2>

The surface light source device of Appendix 1, wherein

the light distribution control element includes a light incident surface to receive the light emitted from the at least one light source; and

the light incident surface is formed to cover the at least one light source.

<Appendix 3>

The surface light source device of Appendix 2, wherein a distance between the light incident surface and the optical axis decreases from the at least one light source toward the first light emitting surface.

<Appendix 4>

The surface light source device of any one of Appendixes 1 to 3, wherein the first light emitting surface and the second light emitting surface are cylindrical surfaces having curvature in a first direction and having no curvature in a second direction perpendicular to the first direction.

<Appendix 5>

The surface light source device of Appendix 4, wherein the at least one light source is arranged in the second direction.

<Appendix 6>

The surface light source device of Appendix 2 or 3, wherein the first light emitting surface and the second light emitting surface are cylindrical surfaces having curvature in a first direction and having no curvature in a second direction perpendicular to the first direction; and the light incident surface has a groove shape extending in the second direction.

<Appendix 7>

The surface light source device of Appendix 6, wherein the at least one light source is arranged in the second direction.

<Appendix 8>

The surface light source device of any one of Appendixes 1 to 7, wherein the light distribution control element includes a region having an irregular shape on the first light emitting surface, the second light emitting surface, or the light reflecting surface.

<Appendix 9>

The surface light source device of any one of Appendixes 2, 3, 6, and 7, wherein the light distribution control element includes a region having an irregular shape on the light incident surface.

<Appendix 10>

The surface light source device of any one of Appendixes 1 to 9, wherein the light distribution control element includes a diffusing material.

<Appendix 11>

The surface light source device of any one of Appendixes 1 to 10, wherein the light distribution control element includes materials having different refractive indexes.

<Appendix 12>

The surface light source device of any one of Appendixes 1 to 11, wherein the light distribution control element includes a light diffusing element or a light reflecting element in a region of the first light emitting surface including the optical axis.

<Appendix 13>

A liquid crystal display apparatus comprising:

the surface light source device of any one of Appendixes 1 to 12; and

a liquid crystal panel to convert planar light emitted from the surface light source device into image light.

<Appendix (2)>

<Appendix 1>

A surface light source device comprising:

at least one light source to emit light; and

at least one light distribution control element to receive the light and change a light distribution of the received light, wherein

the light includes a first light ray and a second light ray;

the at least one light source includes:
a first light emission surface to emit the first light ray; and
a second light emission surface to emit the second light ray in a direction perpendicular to a direction in which the first light ray is emitted, the second light emission surface being formed in a vicinity of the first light emission surface; and

the at least one light distribution control element includes:
a light incident surface to receive the light emitted from the at least one light source;
a first light emitting surface formed at a position through which an optical axis of the at least one light distribution control element passes, the first light emitting surface being a surface at which the first light ray arrives;
a second light emitting surface disposed at an end of the first light emitting surface and formed to extend toward the at least one light source in a direction of the optical axis, the second light emitting surface being a surface at which the second light ray arrives; and
a light reflecting surface disposed at a position facing the first light emitting surface, the light reflecting surface reflecting, toward the second light emitting surface, the first light ray reflected by the first light emitting surface.

<Appendix 2>

The surface light source device of Appendix 1, wherein the at least one light distribution control element includes a diffusing material.

<Appendix 3>

The surface light source device of Appendix 2, wherein the diffusing material is distributed at the light incident surface in a form of a layer.

<Appendix 4>

The surface light source device of any one of Appendixes 1 to 3, wherein the light incident surface is formed to cover the at least one light source.

<Appendix 5>

The surface light source device of any one of Appendixes 1 to 4, wherein a distance between the light incident surface and the optical axis decreases from the at least one light source toward the first light emitting surface.

<Appendix 6>

The surface light source device of any one of Appendixes 1 to 5, wherein the second light emitting surface is inclined so that a distance between the second light emitting surface and the optical axis decreases from the at least one light source toward the first light emitting surface.

<Appendix 7>

The surface light source device of any one of Appendixes 1 to 6, wherein the light reflecting surface has a convex shape projecting toward the first light emitting surface.

<Appendix 8>

The surface light source device of any one of Appendixes 1 to 7, wherein the at least one light distribution control element includes a region having an irregular shape on the first light emitting surface, the second light emitting surface, or the light reflecting surface.

<Appendix 9>

The surface light source device of any one of Appendixes 1 to 8, wherein the at least one light distribution control element includes materials having different refractive indexes.

<Appendix 10>

The surface light source device of any one of Appendixes 1 to 9, wherein the at least one light distribution control element includes a light diffusing element or a light reflecting element in a region of the first light emitting surface including the optical axis.

<Appendix 11>

The surface light source device of any one of Appendixes 1 to 10, wherein the first light emitting surface and the second light emitting surface are cylindrical surfaces having curvature in a first direction and having no curvature in a second direction perpendicular to the first direction.

<Appendix 12>

The surface light source device of Appendix 11, wherein the at least one light source is arranged in the second direction.

<Appendix 13>

The surface light source device of Appendix 11 or 12, wherein the light incident surface has a groove shape extending in the second direction.

<Appendix 14>

The surface light source device of any one of Appendixes 11 to 13, wherein

the at least one light distribution control element comprises at least two light distribution control elements; and

the at least two light distribution control elements are arranged parallel to each other.

<Appendix 15>

A liquid crystal display apparatus comprising:

the surface light source device of Appendix 14; and

a liquid crystal panel to convert planar light emitted from the surface light source device into image light, wherein

the at least two light distribution control elements are arranged to extend in a horizontal direction; and

a center position of the at least two light distribution control elements in a vertical direction is located above a center position of the liquid crystal panel in the vertical direction.

<Appendix 16>

A liquid crystal display apparatus comprising:

the surface light source device of any one of Appendixes 1 to 14; and

a liquid crystal panel to convert planar light emitted from the surface light source device into image light.

### REFERENCE SIGNS LIST

100, 110, 120 liquid crystal display apparatus, 200, 210, 220 surface light source device, 1 liquid crystal panel, 1a display surface, 1b back surface, 2, 3 optical sheet, 4 diffusion plate, 5 reflector, 51 bottom surface, 52 side surface, 53 opening, 54 reflecting member, 6, 6a, 6b, 6c light distribution control element, 61, 61a, 61b light incident surface, 62, 62a, 62b light emitting surface, 63 apex portion, 64 material, 65 transparent material, 66 light diffusing element, 67 light reflecting surface, 68 diffusing layer, 69 particle, 7 light source, 7a, 7b light emission surface, A inclination angle, C, Cs, C₁, C₂ optical axis, Ca, Cb center position, L, L₁ᵣ L₂, L₃, L₄ light ray, R, R₁, R₂ rod.

1. A surface light source device comprising:
at least one light source to emit light; and
at least one light distribution control element to receive the light and change a light distribution of the received light, wherein
the light includes first light rays and second light rays;
the at least one light source includes:
a first light emission surface to emit the first light rays; and
a second light emission surface to emit the second light rays in a direction perpendicular to a direction in which the first light ray is rays are emitted, the second light emission surface being formed in a vicinity of the first light emission surface;
the at least one light distribution control element includes:
a light incident surface to receive the first and second light rays emitted from the at least one light source;
a diffusing layer including a diffusing material to diffuse the received first and second light rays, the diffusing material being distributed on an inner side of the light incident surface in a form of a layer;
a first light emitting surface formed at a position through which an optical axis of the at least one light distribution control element passes, part of the first light rays reaching the first light emitting surface after passing through the diffusing layer without being diffused by the diffusing material;
a second light emitting surface disposed at an end of the first light emitting surface and formed to extend toward the at least one light source in a direction of the optical axis, part of the second light rays reaching the second light emitting surface after passing through the diffusing layer without being diffused by the diffusing material; and
a light reflecting surface disposed at a position facing the first light emitting surface, part of the first light rays being reflected by the light reflecting surface toward the second light emitting surface after reflected by the first light emitting surface;
the first light emitting surface and the second light emitting surface are cylindrical surfaces having curvature in a first direction and having no curvature in a second direction perpendicular to the first direction; and
the light incident surface has a groove shape extending in the second direction.

2. The surface light source device of claim 1, wherein
the diffusing layer is formed entirely around the light incident surface.

3. The surface light source device of claim 1, wherein the light incident surface is formed to cover the at least one light source.

4. The surface light source device of claim 1, wherein a distance between the light incident surface and the optical axis decreases from the at least one light source toward the first light emitting surface.

5. (canceled)

6. The surface light source device of claim 1, wherein the at least one light source comprises a plurality of light sources arranged in the second direction.

7. (canceled)

8. The surface light source device of claim 1, wherein
the at least one light distribution control element comprises at least two light distribution control elements; and
the at least two light distribution control elements are arranged parallel to each other.

9. A liquid crystal display apparatus comprising:
the surface light source device of claim 8; and
a liquid crystal panel to convert planar light emitted from the surface light source device into image light, wherein
the at least two light distribution control elements are arranged to extend in a horizontal direction; and
a center position of the at least two light distribution control elements in a vertical direction is located above a center position of the liquid crystal panel in the vertical direction.

10. A liquid crystal display apparatus comprising:
the surface light source device of claim 1; and
a liquid crystal panel to convert planar light emitted from the surface light source device into image light.

11. The surface light source device of claim 2, wherein the at least one light source comprises a plurality of light sources arranged in the second direction.

12. The surface light source device of claim 3, wherein the at least one light source comprises a plurality of light sources arranged in the second direction.

13. The surface light source device of claim 4, wherein the at least one light source comprises a plurality of light sources arranged in the second direction.

14. The surface light source device of claim 11, wherein
the at least one light distribution control element comprises at least two light distribution control elements; and
the at least two light distribution control elements are arranged parallel to each other.

15. The surface light source device of claim 12, wherein
the at least one light distribution control element comprises at least two light distribution control elements; and
the at least two light distribution control elements are arranged parallel to each other.

16. The surface light source device of claim 13, wherein
the at least one light distribution control element comprises at least two light distribution control elements; and
the at least two light distribution control elements are arranged parallel to each other.

17. The surface light source device of claim 6, wherein
the at least one light distribution control element comprises at least two light distribution control elements; and
the at least two light distribution control elements are arranged parallel to each other.

18. A liquid crystal display apparatus comprising:
the surface light source device of claim 14; and
a liquid crystal panel to convert planar light emitted from the surface light source device into image light, wherein
the at least two light distribution control elements are arranged to extend in a horizontal direction; and
a center position of the at least two light distribution control elements in a vertical direction is located above a center position of the liquid crystal panel in the vertical direction.

19. A liquid crystal display apparatus comprising:
the surface light source device of claim 15; and
a liquid crystal panel to convert planar light emitted from the surface light source device into image light, wherein
the at least two light distribution control elements are arranged to extend in a horizontal direction; and
a center position of the at least two light distribution control elements in a vertical direction is located above a center position of the liquid crystal panel in the vertical direction.

20. A liquid crystal display apparatus comprising:
the surface light source device of claim 16; and
a liquid crystal panel to convert planar light emitted from the surface light source device into image light, wherein
the at least two light distribution control elements are arranged to extend in a horizontal direction; and
a center position of the at least two light distribution control elements in a vertical direction is located above a center position of the liquid crystal panel in the vertical direction.

21. A liquid crystal display apparatus comprising:
the surface light source device of claim 17; and
a liquid crystal panel to convert planar light emitted from the surface light source device into image light, wherein
the at least two light distribution control elements are arranged to extend in a horizontal direction; and
a center position of the at least two light distribution control elements in a vertical direction is located above a center position of the liquid crystal panel in the vertical direction.
